(19) United States
(12) Patent Application Publication
(10) Pub. No.: US 2025/0051235 A1
(43) Pub. Date: Feb. 13, 2025

(54) EARLY-STRENGTH AND QUICK-SETTING ULTRA-HIGH PERFORMANCE CONCRETE (UHPC), AND PREPARATION METHOD AND USE THEREOF

(71) Applicant: QINGDAO UNIVERSITY OF TECHNOLOGY, Qingdao, Shandong (CN)

(72) Inventors: Dongshuai HOU, Qingdao, Shandong (CN); Xinpeng WANG, Qingdao, Shandong (CN); Di WU, Qingdao, Shandong (CN); Mengmeng LI, Qingdao, Shandong (CN); Guannan LI, Qingdao, Shandong (CN); Pan WANG, Qingdao, Shandong (CN)

(21) Appl. No.: 18/721,133

(22) PCT Filed: Jan. 14, 2022
(86) PCT No.: PCT/CN2022/071903

§ 371 Date: Jun. 17, 2024

(30) Foreign Application Priority Data
Dec. 22, 2021 (CN) 202111580483.3

(51) Int. Cl. C04B 28/04; B28B 1/08; C04B 14/06; C04B 14/48; C04B 18/04; C04B 18/14; C04B 24/26; C04B 40/00; C04B 40/02; C04B 103/30

(52) U.S. Cl. CPC C04B 28/04; C04B 14/06; C04B 14/48; C04B 18/0409; C04B 18/146; C04B 24/2641; C04B 40/0042; C04B 40/0046; C04B 40/0067; C04B 40/024; B28B 1/08; C04B 2103/302; C04B 2201/52

(57) ABSTRACT

Provided are early-strength and quick-setting ultra-high performance concrete (UHPC), and a preparation method and use thereof. The early-strength and quick-setting UHPC includes, in parts by mass: 110 parts to 180 parts of a red mud, 70 parts to 80 parts of a silica fume, 130 parts to 290 parts of a cement, 400 parts to 500 parts of a quartz sand, 10 parts to 15 parts of a water-reducing agent, 80 parts to 100 parts of water, and 50 parts to 75 parts of a steel fiber. The preparation method includes: subjecting the silica fume, the cement, the quartz sand, and the red mud to first mixing to obtain a first premix; subjecting the first premix, the water, and the water-reducing agent to second mixing to obtain a second premix; and subjecting the second premix and the steel fiber to third mixing to obtain the early-strength and quick-setting UHPC.

This application is a U.S. national stage application of International Patent Application No. PCT/CN2022/071903, filed Jan. 14, 2022, which claims the benefit of and priority to Chinese Patent Application No. 202111580483.3, filed Dec. 22, 2021, each of which is hereby incorporated by reference herein in its entirety.

### TECHNICAL FIELD

The present disclosure belongs to the technical field of concretes, and specifically relates to an early-strength and quick-setting ultra-high performance concrete (UHPC), and a preparation method and use thereof.

### BACKGROUND

Red mud is an alkaline solid waste produced in the process of production of alumina, and affected by bauxite grade, and the production of 1 t of alumina leads to 1 t to 1.5 t of red mud. Currently, red mud is mainly disposed through landfill, which occupies a large amount of land. In addition, the alkali dissolution caused by the high alkalinity (with a pH value of 10 to 12.5) of red mud also results in a series of environmental problems such as land salinization and groundwater pollution.

At present, the methods for recycling red mud mainly include preparation of adsorbents, extraction of valuable metals, and production of cements. However, red mud (especially Bayer red mud) exhibits strong alkalinity (with a pH of greater than 10), and thus red mud needs to be subjected to dealkalization treatment or neutralized with an acidic neutralizing agent before being recycled as above, which increases the cost and difficulty of red mud recycling. In terms of cement hydration, the high alkalinity of red mud could accelerate the hydration of cement and promote the setting hardening and early strength development of concrete. However, if a content of red mud is low (less than 150 kg/m³), an alkali supply is insufficient, leading to a limited early strength effect. If a content of red mud is high, the red mud exerts a quick-setting effect, but results in obvious deterioration of performance of concrete. In addition, a large amount of red mud may increase a radioactivity risk of corresponding concrete products.

In summary, the existing red mud recycling techniques have problems such as complicated processes (a dealkalization pretreatment is required) and alkali resistance and uncertain radioactivity of products.

### SUMMARY

The present disclosure aims to provide an early-strength and quick-setting UHPC, and a preparation method and use thereof. In the present disclosure, red mud is added as an early-strength agent to a UHPC at a large amount, which could significantly shorten a setting time of the concrete, promote the early-strength development, alleviate the red mud accumulation and environmental pollution caused thereby, and greatly reduce the alkali dissolution and radioactivity risks of red mud while ensuring the excellent mechanical performance and durability of the product.

To achieve the above objects, the present disclosure provides the following technical solutions.

The present disclosure provides an early-strength and quick-setting UHPC, including the following components in parts by mass:
110 parts to 180 parts of a red mud, 70 parts to 80 parts of a silica fume, 130 parts to 290 parts of a cement, 400 parts to 500 parts of a quartz sand, 10 parts to 15 parts of a water-reducing agent, 80 parts to 100 parts of water, and 50 parts to 75 parts of a steel fiber.

In some embodiments, the quartz sand has a particle size of 0.075 mm to 0.6 mm;
the red mud has a particle size of 0.01 mm to 0.075 mm; and
the silica fume has an average particle size of 300 nm and an activity index of higher than or equal to 100%.

In some embodiments, the water-reducing agent is an efficient polycarboxylic acid water-reducing agent, and the efficient polycarboxylic acid water-reducing agent has a solid content of 20% and a water-reducing rate of higher than or equal to 35%.

In some embodiments, the cement is an ordinary Portland cement with a strength grade of 52.5.

In some embodiments, the steel fiber has a length of 13 mm, a diameter of 0.65 mm, and a tensile strength of higher than or equal to 2,000 MPa; and the steel fiber is a long straight copper-plated steel fiber.

In some embodiments, the red mud is Bayer red mud.

In some embodiments, the quartz sand has a specific gravity of 2,560 kg/m³.

The present disclosure further provides a method for preparing the early-strength and quick-setting UHPC as described in the above solutions, including the following steps:
subjecting the silica fume, the cement, the quartz sand, and the red mud to first mixing to obtain a first premix;
subjecting the first premix, the water, and the water-reducing agent to second mixing to obtain a second premix; and
subjecting the second premix and the steel fiber to third mixing to obtain the early-strength and quick-setting UHPC.

In some embodiments, the first mixing is conducted for 120 s to 180 s, the second mixing is conducted for 240 s to 360 s, and the third mixing is conducted for 60 s.

The present disclosure also provides use of the early-strength and quick-setting UHPC as described in the above solutions or an early-strength and quick-setting UHPC prepared by the method as described in the above solutions in a building material or a decorative material.

In some embodiments, the use includes the following steps:
pouring the early-strength and quick-setting UHPC into a mold, and conducting vibrating, standing, and demolding in sequence to obtain a prefabricated component; and
curing the prefabricated component under a steam curing condition; or includes the following steps:
pouring the early-strength and quick-setting UHPC, and then conducting film-covering curing.

In some embodiments, the vibrating is conducted for 60 s to 180 s.

In some embodiments, the standing is conducted for 3 h.

In some embodiments, the steam curing condition includes heating to 45° C. at a rate of 5° C./min, and conducting pre-curing for 12 h; then heating to 100° C. at a rate of 11° C./min, and conducting steam-curing for 6 h; and then cooling to room temperature at a rate of 6.7° C./h.

The present disclosure provides an early-strength and quick-setting UHPC, including the following components in parts by mass: 110 parts to 180 parts of a red mud, 70 parts to 80 parts of a silica fume, 130 parts to 290 parts of a cement, 400 parts to 500 parts of a quartz sand, 10 parts to 15 parts of a water-reducing agent, 80 parts to 100 parts of water, and 50 parts to 75 parts of a steel fiber.

In the present disclosure, the high alkalinity of red mud could significantly increase the alkali concentration of a UHPC slurry, promote the cement hydration, shorten an induction period, accelerate setting, and improve an early strength. Further, the red mud has a low particle size (being between the silica fume and the cement), and thus could also provide a nucleation site for hydration products to accelerate the hydration, thereby shortening a setting time and improving an early strength. On this basis, a composition of a cement-based material is optimized to give full play to a volcanic ash effect and a filling effect of red mud, thereby allowing the preparation of a cement-based material with an ultra-high strength and excellent durability. In the present disclosure, red mud is added to UHPC to replace some cementing materials, alleviating problems of the red mud accumulation and environmental pollution caused thereby, reducing the consumption of cementing materials such as cement and silica fume, the emission of CO₂, and the preparation cost of UHPC, and promoting the safe recycling of red mud. Moreover, the early-strength and quick-setting UHPC according to the present disclosure has a dense structure, and could exert a prominent shielding effect for alkali leaching of red mud. In addition, the early-strength and quick-setting UHPC according to the present disclosure could shield the radioactivity of a red mud slurry to greatly reduce a radioactivity risk, which is conducive to the safety and long-term operation and maintenance of a red mud-based UHPC component and allows the safe, efficient, and high-value recycling of red mud.

Test results in the examples show that the early-strength and quick-setting UHPC according to the present disclosure has a relatively-low leachable alkali capacity meeting a requirement in the standard “Method for Determination of Leachable Harmful Substances in Wall Materials”, and has significantly-lower radionuclide values than that of red mud, where both an internal exposure index I_{Ra} and an external exposure index Iᵣ of the early-strength and quick-setting UHPC are lower than those of red mud respectively, and are lower than 1, which meets the requirements in national specifications for the internal exposure index and external exposure index.

The present disclosure also provides a method for preparing the early-strength and quick-setting UHPC as described in the above solutions by mixing the components. The method could avoid the sedimentation and aggregation of components while ensuring the full dispersion of particles and the hydration of cementing materials.

The present disclosure also provides use of the early-strength and quick-setting UHPC as described in the above solutions in a building material and a decorative material. The early-strength and quick-setting UHPC according to the present disclosure is reddish-brown and thus has an appearance beautification effect. The early-strength and quick-setting UHPC meets the requirements in the national standards GB 6566-2010 “Limits of Radionuclides in Building Materials” and GB/T 39804-2021 “Method for Determination of Leachable Harmful Substances in Wall Materials”, reduces a cost of a building material, and meets the requirements such as safety, economy, and environmental protection. The early-strength and quick-setting UHPC could be used in highways, bridge deck pavement, and prefabricated components to reduce costs and shorten construction periods while ensuring the safe and stable operation and maintenance of components.

### DETAILED DESCRIPTION OF THE EMBODIMENTS

The present disclosure provides an early-strength and quick-setting UHPC, including (or consisting of) the following components in parts by mass:

110 parts to 180 parts of a red mud, 70 parts to 80 parts of a silica fume, 130 parts to 290 parts of a cement, 400 parts to 500 parts of a quartz sand, 10 parts to 15 parts of a water-reducing agent, 80 parts to 100 parts of water, and 50 parts to 75 parts of a steel fiber.

Unless otherwise specified, there is no special requirements for a source of each component in the early-strength and quick-setting UHPC according to the present disclosure, and components well-known to those skilled in the art may be used.

In some embodiments, the early-strength and quick-setting UHPC according to the present disclosure includes, in parts by mass, 110 parts to 180 parts of a red mud, preferably 115 parts to 179 parts, and more preferably 119 to 178 parts. In some embodiments, the red mud has a particle size of 0.01 mm to 0.075 mm, preferably 0.02 mm to 0.06 mm, and more preferably 0.03 mm to 0.05 mm. In some embodiments, the red mud is Bayer red mud.

In some embodiments, based on the parts by mass of the red mud, the early-strength and quick-setting UHPC according to the present disclosure includes 70 parts to 80 parts of a silica fume, preferably 71 parts to 78 parts, and more preferably 72 parts to 76 parts. In some embodiments, the silica fume has an average particle size of 300 nm. In some embodiments, the silica fume has an activity index of higher than or equal to 100%. In an embodiment of the present disclosure, the silica fume is purchased from Elkem.

In some embodiments, based on the parts by mass of the red mud, the early-strength and quick-setting UHPC according to the present disclosure includes 130 parts to 290 parts of a cement, preferably 140 parts to 280 parts, and more preferably 150 parts to 270 parts. In some embodiments, the cement is an ordinary Portland cement with a strength grade of 52.5.

In some embodiments, based on the parts by mass of the red mud, the early-strength and quick-setting UHPC according to the present disclosure includes 400 parts to 500 parts of a quartz sand, preferably 410 parts to 490 parts, and more preferably 420 parts to 480 parts. In some embodiments, the quartz sand has a particle size of 0.075 mm to 0.6 mm, preferably 0.1 mm to 0.5 mm, and more preferably 0.2 mm to 0.4 mm. In some embodiments, the quartz sand has continuous gradation, and the quartz sand has a specific gravity of 2,560 kg/m³. In an embodiment of the present disclosure, the quartz sand is purchased from Hunan Yangmao Quartz Sand Filter Material Co., Ltd in China.

In some embodiments, based on the parts by mass of the red mud, the early-strength and quick-setting UHPC according to the present disclosure includes 10 parts to 15 parts of a water-reducing agent, preferably 11 parts to 14 parts, and more preferably 12 parts to 13 parts. In some embodiments, the water-reducing agent is an efficient polycarboxylic acid water-reducing agent. In some embodiments, the efficient polycarboxylic acid water-reducing agent has a solid content of 20%. In some embodiments, the water-reducing agent has a water-reducing rate of higher than or equal to 35%. In a specific embodiment of the present disclosure, the efficient polycarboxylic acid water-reducing agent is an efficient polycarboxylic acid water-reducing agent produced by Jiangsu Sobute New Materials Co., Ltd in China.

In some embodiments, based on the parts by mass of the red mud, the early-strength and quick-setting UHPC according to the present disclosure includes 80 parts to 100 parts of water, preferably 83 parts to 95 parts, and more preferably 85 parts to 93 parts.

In some embodiments, based on the parts by mass of the red mud, the early-strength and quick-setting UHPC according to the present disclosure includes 50 parts to 75 parts of a steel fiber, preferably 55 parts to 70 parts, and more preferably 60 parts to 65 parts. In some embodiments, the steel fiber has a length of 13 mm, a diameter of 0.65 mm, and a tensile strength of higher than or equal to 2,000 MPa. In some embodiments, the steel fiber is a long straight copper-plated steel fiber.

The present disclosure also provides a method for preparing the early-strength and quick-setting UHPC as described in the above solutions, including the following steps:
subjecting the silica fume, the cement, the quartz sand, and the red mud to first mixing to obtain a first premix;
subjecting the first premix, the water, and the water-reducing agent to second mixing to obtain a second premix; and
subjecting the second premix and the steel fiber to third mixing to obtain the early-strength and quick-setting UHPC.

The silica fume, the cement, the quartz sand, and the red mud are subjected to first mixing to obtain a first premix. In some embodiments, the first mixing is conducted for 120 s to 180 s and preferably 130 s to 170 s. In some embodiments, a device for the first mixing is a mortar stirring pot. In some embodiments, the first mixing is conducted by stirring; the stirring is conducted at a rotational speed of 135 rpm to 145 rpm and preferably 138 rpm to 143 rpm; and the stirring is conducted for 90 s.

After the first premix is obtained, the first premix, the water, and the water-reducing agent are subjected to second mixing to obtain a second premix.

In some embodiments, the second mixing is conducted for 240 s to 360 s and preferably 250 s to 350 s. In some embodiments, the second mixing is conducted by stirring; and the stirring is conducted at a rotational speed of 135 rpm to 145 rpm and preferably 138 rpm to 143 rpm.

After the second premix is obtained, the second premix and the steel fiber are subjected to third mixing to obtain the early-strength and quick-setting UHPC.

In some embodiments, the third mixing is conducted for 60 s. In some embodiments, the third mixing is conducted by stirring; and the stirring is conducted at a rotational speed of 135 rpm to 145 rpm and preferably 138 rpm to 143 rpm.

The present disclosure also provides use of the early-strength and quick-setting UHPC described above in a building material or a decorative material.

In some embodiments, the use of the early-strength and quick-setting UHPC includes the following steps: pouring the early-strength and quick-setting UHPC into a mold, then conducting vibrating, standing, and demolding in sequence to obtain a prefabricated component; and curing the prefabricated component under a steam curing condition; or
includes the following steps:
pouring the early-strength and quick-setting UHPC, and conducting film-covering curing.

In some embodiments, the vibrating is conducted for 60 s to 180 s and preferably 70 s to 170 s. In some embodiments, the standing is conducted for 3 h; and the standing is conducted under a condition of covering a plastic film. In some embodiments, the steam curing condition includes: heating to 45° C. at a rate of 5° C./min, and conducting pre-curing for 12 h; then heating to 100° C. at a rate of 11° C./min, and conducting steam-curing for 6 h; and then cooling to room temperature at a rate of 6.7° C./h.

In order to further illustrate the present disclosure, the early-strength and quick-setting UHPC according to the present disclosure is described in detail below in conjunction with examples and drawings, but these examples should not be understood as limiting the scope of the present disclosure.

### Example 1

In parts by mass, 72 parts of a silica fume, 288 parts of a cement, 119 parts of a red mud, and 425 parts of a quartz sand were mixed and added to a mortar stirring pot and then stirred for 90 s at a rotational speed of 140±5 rpm to obtain a first premix. 84 parts of water and 12 parts of a water-reducing agent were added to the first premix, and then stirred for 240 s at a rotational speed of 140±5 rpm to obtain a slurry. 50 parts of a steel fiber were added to the slurry, and then stirred for 60 s at a rotational speed of 140±5 rpm to obtain an early-strength and quick-setting UHPC.

In the early-strength and quick-setting UHPC, the red mud replaces 40% of the volume of the original cement. The early-strength and quick-setting UHPC was denoted as VC40.

### Example 2

In parts by mass, 72 parts of a silica fume, 180 parts of a cement, 148 parts of a red mud, and 425 parts of a quartz sand were mixed and added to a mortar stirring pot and then stirred for 90 s at a rotational speed of 140±5 rpm to obtain a first premix. 84 parts of water and 12 parts of a water-reducing agent were added to the first premix, and then stirred for 240 s at a rotational speed of 140±5 rpm to obtain a slurry. 50 parts of a steel fiber were added to the slurry, and then stirred for 60 s at a rotational speed of 140±5 rpm to obtain an early-strength and quick-setting UHPC.

In the early-strength and quick-setting UHPC, the red mud replaces 50% of the volume of the original cement. The early-strength and quick-setting UHPC was denoted as VC50.

### Example 3

In parts by mass, 72 parts of a silica fume, 144 parts of a cement, 178 parts of a red mud, and 425 parts of a quartz sand were mixed and added to a mortar stirring pot and then stirred for 90 s at a rotational speed of 140±5 rpm to obtain a first premix. 84 parts of water and 12 parts of a water-reducing agent were added to the first premix, and then stirred for 240 s at a rotational speed of 140±5 rpm to obtain a slurry. 50 parts of a steel fiber were added to the slurry, and then stirred for 60 s at a rotational speed of 140±5 rpm to obtain an early-strength and quick-setting UHPC.

In the early-strength and quick-setting UHPC, the red mud replaces 60% of the volume of the original cement. The early-strength and quick-setting UHPC was denoted as VC60.

### Comparative Example 1

In parts by mass, 72 parts of a silica fume, 360 parts of a cement, and 425 parts of a quartz sand were mixed and added to a mortar stirring pot and then stirred for 90 s at a rotational speed of 140±5 rpm to obtain a premix; 84 parts of water and 12 parts of a water-reducing agent were added to the premix, and then stirred for 240 s at a rotational speed of 140±5 rpm to obtain a slurry. 50 parts of a steel fiber were added to the slurry, and then stirred for 60 s at a rotational speed of 140±5 rpm to obtain a UHPC without red mud, which was denoted as Ref. 1.

### Comparative Example 2

In parts by mass, 69 parts of a cement, 103 parts of a red mud, and 517 parts of a quartz sand were mixed and added to a mortar stirring pot and then stirred for 90 s at a rotational speed of 140±5 rpm to obtain a premix. 86 parts of water were added to the premix, and then stirred for 240 s at a rotational speed of 140±5 rpm to obtain a UHPC without a silica fume, a water-reducing agent, and a steel fiber, which was denoted as Ref.2.

### Test Example 1

The UHPCs prepared in Examples 1 to 3 and Comparative Examples 1 and 2 each were tested for a setting time, a 3 h strength, a 28-day strength, and durability, and test methods were conducted as follows:

Setting time test: According to JGJ/T70-2009 “Standard for Test Method of Basic Properties of Building Mortar”, a setting time of a UHPC slurry was determined.

Compressive strength and flexural strength tests: The early-strength and quick-setting UHPCs prepared in Examples 1 to 3 and the UHPCs prepared in Comparative Examples 1 and 2 each were poured into a mold, the mold was vibrated on a vibrating table for 180 s to make the UHPC therein compact, then a resulting surface was covered with a plastic film. After 1 day, the mold was removed to obtain a prefabricated component. The prefabricated component was cured under a standard curing condition (at a temperature of 18° C. to 22° C., and relative humidity of greater than 95%) and then air-dried. According to GB 17671-1999 “Test Method for Strength of Cement Mortar”, a compressive strength and a flexural strength were tested on a universal pressure testing machine by using 40 mm×40 mm×40 mm and 40 mm×40 mm×160 mm molded components, respectively.

Durability test: A cylindrical molded component with a diameter of 100 mm and a height of 50±2 mm was used to evaluate the durability through an electric flux test and a rapid chloride ion migration (RCM) test.

Test results are shown in Table 1.

TABLE 1
Performance test results of the UHPCs prepared in
Examples 1 to 3 and Comparative Examples 1 and 2

| | | | | | | Comparative | Comparative |
|---|---|---|---|---|---|---|---|
| | | | Example 1 | Example 2 | Example 3 | Example 1 | Example 2 |
| Setting | Initial setting | | 40 | 32 | 21 | 369 | 59 |
| time/min | Final setting | | 59 | 48 | 35 | 479 | 85 |
| Compressive | 3 | h | 22.7 | 17.0 | 15.1 | — | 1.1 |
| strength/MPa | 28 | days | 132.2 | 121.5 | 104.4 | 159.7 | 19.3 |

| | | | | | | |
|---|---|---|---|---|---|---|
| Durability | Electric flux/C | 67 | 73 | 97 | 54 | 3500 |

According to the results in Table 1, it can be seen that the early-strength and quick-setting UHPCs prepared in Examples 1 to 3 have a relatively-short initial setting time, where the initial setting is completed within 20 min to 40 min, and the final setting is completed within 60 min, indicating that they have relatively-short setting time. The early-strength and quick-setting UHPCs prepared in Examples 1 to 3 have a 3 h strength of 15.1 MPa to 22.7 MPa. The early-strength and quick-setting UHPCs prepared in Examples 1 to 3 have an excellent 28-day strength and durability, where the 28-day strength is higher than 100 MPa that indicates an ultra-high strength, and an electric flux is lower than 100 C that is in a negligible range of chloride ion permeation. The UHPC without a red mud as an early-strength agent prepared in Comparative Example 1 has a setting time of 369 min to 479 min, and the UHPC cannot be set within 3 h, which does not meet the requirements of early-strength and quick-setting concretes. In Comparative Example 2, the ordinary concrete system in which a red mud alone is added as an early-strength agent has a low early strength, where a 3 h strength is merely 1.1 MPa and a 28-day strength is merely 19.3 MPa, indicating that a red mud content needs to be greatly increased to allow a quick-setting effect of an ordinary concrete system. However, a high red mud content significantly reduces an early strength of an ordinary concrete, and also limits the development of a late strength of concrete.

The early-strength and quick-setting UHPCs prepared in Examples 1 to 3 of the present disclosure all have a lower electric flux than that of the UHPCs prepared in Comparative Examples 1 and 2, indicating that the early-strength and quick-setting UHPCs prepared in Examples 1 to 3 of the present disclosure exhibit higher durability than that of the traditional UHPC prepared in Comparative Example 1 and the ordinary concrete prepared in Comparative Example 2.

### Test Example 2

The early-strength and quick-setting UHPCs prepared in Examples 1 to 3 each were subjected to radioactivity test and an alkalinity test. The radioactivity test method was conducted as follows: a sample to be tested was ground into particles with a particle size of less than 0.16 mm, sealed, and placed for 7 days, and then a radioactivity of each nuclide was tested by a low-background multi-channel gamma-ray spectrometer; and an internal exposure index (I_{Ra}) and an external exposure index (Iᵣ) were calculated. Statistical results are shown in Table 2.

TABLE 2
Radioactivity and alkalinity test results of Examples 1 to 3

| | | | Example 1 | Example 2 | Example 3 |
|---|---|---|---|---|---|
| Radioactivity | Specific | ²²⁶Ra | 41.4 | 72.2 | 95.0 |
| | radioactivity/ | ²³²Th | 95.8 | 113.4 | 151.1 |
| | (Bq/kg) | ⁴⁰Ka | 320.1 | 348.2 | 365.8 |
| | Internal and | I_{Ra} | 0.207 | 0.319 | 0.475 |
| | external | Iᵣ | 0.556 | 0.733 | 0.825 |
| | exposure | | | | |
| | indexes | | | | |

| | | | | |
|---|---|---|---|---|
| Alkalinity | Na⁺ concentration/ppm | 63.5 | 88.3 | 101.5 |

It can be seen from Table 2 that the early-strength and quick-setting UHPCs prepared in Examples 1 to 3 have a relatively-low specific radioactivity, where a specific radioactivity of ²²⁶Ra is 40 Bq/kg to 95 Bq/kg, a specific radioactivity of ²³²Th is 95 Bq/kg to 150 Bq/kg, a specific radioactivity of ⁴⁰Ka is 320 Bq/kg to 365 Bq/kg, and internal and external exposure indexes I_{Ra} and Iᵣ both are less than 1 and conform to the internal and external exposure indexes required in the GB6566-2010 “Limits of Radionuclides in Building Materials”. The early-strength and quick-setting UHPCs prepared in Examples 1 to 3 have a relatively-low leachable alkali capacity (Na⁺ ions), which meets the requirement for safe use of building materials in the GBT 39804-2021 “Method for Determination of Leachable Harmful Substances in Wall Materials”.

In accordance with a simplified life cycle assessment method (Damineli B L, Kemeid F M, Aguiar P S, et al. Measuring the eco-efficiency of cement use [J]. Cement and Concrete Composites, 2010, 32 (8): 555-562) and research of Aïtcin (Aïtcin P-C. Cements of yesterday and today: concrete of tomorrow [J]. Cement and Concrete Research, 2000, 30 (9): 1349-1359), a carbon emission and cost under a unit performance index (1 MPa) were used as indexes for evaluating environmental and economic benefits of a concrete. The early-strength and quick-setting UHPCs prepared in Examples 1 and 2 were compared with the UHPC prepared in Comparative Example 1 in terms of an energy consumption (based on a carbon dioxide emission) and a cost. Results are shown in Table 3.

TABLE 3
Comparison of concretes in terms
of an energy consumption and cost

| | | | | | Water- | |
|---|---|---|---|---|---|---|
| Group | | Silica | Red | Quartz | reducing | Steel |
| Component (/kg) | Cement | fume | mud | sand | agent | fiber |
| CO₂ | 0.476 | 0.00188 | 0 | 0.0234 | 0.944 | 0 |
| emission (kg) | | | | | | |
| Cost (yuan) | 0.55 | 2.3 | 0 | 0.2 | 6 | 12 |

| | CO₂ | CO₂ | | |
|---|---|---|---|---|
| | emission | emission/ | Cost | Cost/ |
| Group | (kg/m³) | strength | (yuan/m³) | strength |
| UHPC | 462.9 | 2.89 | 4274 | 26.76 |
| Early-strength and | 310.5 | 2.35 | 2507 | 18.96 |
| quick-setting UHPC | | | | |
| (VC40) | | | | |
| Early-strength and | 224.5 | 1.84 | 2408 | 19.81 |
| quick-setting UHPC | | | | |
| (VC50) | | | | |
| Early-strength and | 138.5 | 1.33 | 2309 | 22.12 |
| quick-setting UHPC | | | | |
| (VC60) | | | | |

It can be seen from Table 3 that the preparation of UHPC has a large energy consumption and a high cost, with a carbon dioxide emission of 462.9 kg/m³ and a cost of 4,274 yuan/m³. The early-strength and quick-setting UHPCs according to the present disclosure have a small energy consumption and a low cost, where a carbon dioxide emission of VC60 is 138.5 kg/m³ and a cost of VC60 is 2,309 yuan/m³, indicating that the early-strength and quick-setting UHPCs according to the present disclosure have a lower preparation cost and a smaller energy consumption than the conventional UHPC.

For example, for per cubic meter of UHPC, VC60 could reduce a preparation cost by 45.9% reduce a CO₂ emission by 70.7%, and recycle 371 kg of red mud. With an actual bridge project as an example, a 15 cm-thick steel-UHPC composite bridge deck was paved, where a total amount of UHPC was 6618.8 m³. Statistical results of concrete amounts of bridge decks are shown in Table 4.

TABLE 4
Statistical results of UHPC amounts of bridge decks

| | | | UHPC (m³) | | |
|---|---|---|---|---|---|
| | | Number of | Single | | |
| Type | No. | sheets/paths | sheet/path | Total | Total |
| Cast-in- | A | 2 | 67.20 | 134.4 | 6420.3 |
| place in a | B | 4 | 62.20 | 248.8 | |
| factory | C | 76 | 71.71 | 5449.6 | |
| | D | 2 | 84.49 | 179.0 | |
| | E | 2 | 39.83 | 79.7 | |
| | F | 1 | 38.16 | 38.2 | |
| | G | 4 | 72.68 | 290.7 | |
| Cast-in- | Class A | 84 | 2.07 | 174.1 | 198.5 |
| place at a | Class B | 2 | 5.37 | 10.7 | |
| construction | Class C | 4 | 1.98 | 7.9 | |
| site | Cast-in-place | 2 | 2.84 | 5.7 | |
| | at a pier top | | | | |

It can be seen from Table 4 that the UHPC according to the present disclosure could reduce a cost by about 12.98 million yuan, reduce a carbon dioxide emission treatment cost by 470,000 yuan (a treatment fee is calculated according to 0.22 yuan/kg), and solidify nearly 1,200 t of red mud.

From the above examples, it can be seen that the early-strength and quick-setting UHPC according to the present disclosure has a relatively-high early strength, a short setting time, and an ultra-high late strength of concrete, which meets the strength and construction time requirements of UHPC in construction of bridge structures and paving decorative components. The early-strength and quick-setting UHPC also has excellent durability, a relatively-low preparation cost, and a small energy consumption. The present disclosure allows the safe and efficient recycling of red mud.

The above description of examples is merely provided to help illustrate the method of the present disclosure and the concept thereof. It should be noted that, several improvements and modifications may be made by a person of ordinary skill in the art without departing from the principle of the present disclosure, and these improvements and modifications should also fall within the scope of the present disclosure. Such modifications to these examples are obvious to those skilled in the art, and the general principles defined herein may be implemented in other examples without departing from the spirit or scope of the present disclosure. Thus, the present disclosure is not limited to the examples shown herein but falls within the widest scope consistent with the principles and features disclosed herein.

1. An early-strength and quick-setting ultra-high performance concrete (UHPC), comprising the following components in parts by mass:
110 parts to 180 parts of a red mud, 70 parts to 80 parts of a silica fume, 130 parts to 290 parts of a cement, 400 parts to 500 parts of a quartz sand, 10 parts to 15 parts of a water-reducing agent, 80 parts to 100 parts of water, and 50 parts to 75 parts of a steel fiber.

2. The early-strength and quick-setting UHPC according to claim 1,
wherein the quartz sand has a particle size of 0.075 mm to 0.6 mm;
the red mud has a particle size of 0.01 mm to 0.075 mm; and
the silica fume has an average particle size of 300 nm and an activity index of higher than or equal to 100%.

3. The early-strength and quick-setting UHPC according to claim 1, wherein the water-reducing agent is an efficient polycarboxylic acid water-reducing agent, and the efficient polycarboxylic acid water-reducing agent has a solid content of 20% and a water-reducing rate of higher than or equal to 35%.

4. The early-strength and quick-setting UHPC according to claim 1, wherein the cement is an ordinary Portland cement with a strength grade of 52.5.

5. The early-strength and quick-setting UHPC according to claim 1, wherein the steel fiber has a length of 13 mm, a diameter of 0.65 mm, and a tensile strength of higher than or equal to 2,000 MPa; and the steel fiber is a long straight copper-plated steel fiber.

6. The early-strength and quick-setting UHPC according to claim 1, wherein the red mud is Bayer red mud.

7. The early-strength and quick-setting UHPC according to claim 1, wherein the quartz sand has a specific gravity of 2,560 kg/m³.

8. A method for preparing the early-strength and quick-setting UHPC according to claim 1, comprising the following steps:
subjecting the silica fume, the cement, the quartz sand, and the red mud to first mixing to obtain a first premix;
subjecting the first premix, the water, and the water-reducing agent to second mixing to obtain a second premix; and
subjecting the second premix and the steel fiber to third mixing to obtain the early-strength and quick-setting UHPC.

9. The method according to claim 8, wherein the first mixing is conducted for 120 s to 180 s, the second mixing is conducted for 240 s to 360 s, and the third mixing is conducted for 60 s.

10. A method for preparing a building material or a decorative material, comprising using the early-strength and quick-setting UHPC according to claim 1.

11. The method according to claim 10, comprising the following steps:
pouring the early-strength and quick-setting UHPC into a mold, and conducting vibrating, standing, and demolding in sequence to obtain a prefabricated component; and
curing the prefabricated component under a steam curing condition; or
comprising the following steps:
pouring the early-strength and quick-setting UHPC, and then conducting film-covering curing.

12. The method according to claim 11, wherein the vibrating is conducted for 60 s to 180 s.

13. The method according to claim 11, wherein the standing is conducted for 3 h.

14. The method according to claim 11, wherein the steam curing condition comprises heating to 45° C. at a rate of 5° C./min, and conducting pre-curing for 12 h; then heating to 100° C. at a rate of 11° C./min, and conducting steam-curing for 6 h; and then cooling to room temperature at a rate of 6.7° C./h.

15. The early-strength and quick-setting UHPC according to claim 2, wherein the red mud is Bayer red mud.

16. The early-strength and quick-setting UHPC according to claim 2, wherein the quartz sand has a specific gravity of 2,560 kg/m³.

17. The method for preparing the early-strength and quick-setting UHPC according to claim 10, wherein the quartz sand has a particle size of 0.075 mm to 0.6 mm;
the red mud has a particle size of 0.01 mm to 0.075 mm; and
the silica fume has an average particle size of 300 nm and an activity index of higher than or equal to 100%.

18. The method for preparing the early-strength and quick-setting UHPC according to claim 10, wherein the water-reducing agent is an efficient polycarboxylic acid water-reducing agent, and the efficient polycarboxylic acid water-reducing agent has a solid content of 20% and a water-reducing rate of higher than or equal to 35%.

19. The method for preparing the early-strength and quick-setting UHPC according to claim 10, wherein the cement is an ordinary Portland cement with a strength grade of 52.5.

20. The method for preparing the early-strength and quick-setting UHPC according to claim 10, wherein the steel fiber has a length of 13 mm, a diameter of 0.65 mm, and a tensile strength of higher than or equal to 2,000 MPa; and the steel fiber is a long straight copper-plated steel fiber.
